(19) United States
(12) Patent Application Publication
(10) Pub. No.: US 2025/0214476 A1
(43) Pub. Date: Jul. 3, 2025

(54) ELECTRIC VEHICLE SUPPLY EQUIPMENT, CHARGER, CHARGING SYSTEM AND METHOD FOR CONTROLLING AN ELECTRIC VEHICLE SUPPLY EQUIPMENT

(71) Applicant: CHALLENGER X AS, Billingstad (NO)

(72) Inventor: Truls HULBY, Jessheim (NO)

(73) Assignee: DEFA AS, Nesbyen (NO)

(21) Appl. No.: 18/283,617

(22) PCT Filed: Mar. 25, 2022
(86) PCT No.: PCT/NO2022/050075

§ 371 Date: Sep. 22, 2023

(30) Foreign Application Priority Data
Mar. 26, 2021 (NO) 20210399

(51) Int. Cl. B60L 53/68; B60L 53/62; H02J 7/00; H02J 13/00

(52) U.S. Cl. CPC B60L 53/68; B60L 53/62; H02J 7/0031; H02J 13/00006

(57) ABSTRACT

The disclosure relates to an electric vehicle supply equipment for charging electrical vehicles comprising internal circuitry with an input of isolated conductors; an output of isolated conductors being arranged to be connected to the input conductors, the output conductors being connectable to an electric vehicle for providing power for charging at least one battery; a primary set of relays, each relay within the set being configured to selectively connect or disconnect electrical power provided from the main distribution cable via the input conductors to the output of isolated conductors, characterized in that the primary set of relays consists/comprises of seven relays, configured to selectively connect or disconnect electrical power provided from the main distribution cable via the input conductors in response to a second input signal; and a safety relay, configured to connect or disconnect electrical power provided from the main distribution cable in response to a first input signal.

### CROSS-REFERENCE TO RELATED APPLICATIONS

This application is a U.S. national stage application under 35 U.S.C. § 371 of International Application No. PCT/NO2022/050075, filed Mar. 25, 2022, which claims the priority of NO Application No. 20210399, filed Mar. 26, 2021, the entire contents of each priority application is incorporated herein by reference.

### FIELD OF THE DISCLOSURE

Embodiments herein relate to an electric vehicle supply equipment for charging of electrical vehicles. Embodiments herein further relate to an electric vehicle charger, a charging system for electric vehicles and a method for controlling an electric vehicle supply equipment.

### BACKGROUND OF THE DISCLOSURE

Electric vehicles, EVs are becoming more and more common, and the demand for charging solutions for EVs is increasing. An EV typically comprises one or more electric motors for propulsion of the EV, and one or more electric storage devices in form batteries. Charging of EV batteries may be performed via a cable, which is supplying electricity from the grid to a charging port of the EV. The electricity may be provided directly from the grid, via an ordinary wall socket, or via any kind of suitable electrical vehicle supply equipment EVSE such as a wall box or electrical vehicle charging station.

In international standards for EV charging four different modes are defined. In Mode 1 the EV is connected to the power grid through standard socket outlets. This mode is associated with some drawbacks in form of long charging time, heating of the sockets and cables etc. Also in Mode 2, the EV is connected to the power grid via socket outlets. Charging is performed via a single-phase or three-phase network and installation of an earthing cable. The cable between the socket and the EV is equipped with a protection device. However, EV charging requires a lot of power over long periods of time and domestic sockets are not designed for this. This may cause gradual damage to the socket. Further, this kind of charging often limits charging to 10A and 2.3 kW, which is far below the full charging capacity of new EVs.

Mode 3 charging, including an EV-charger, charging station or wall box, often has a dedicated circuit of 16A or more, thereby allowing higher charging capacity for the EV. Charging stations may be provided with a mounted cable or an outlet for separate Mode 3 cables, which are available in different dimensions. With a 16A circuit a charging effect may be increased to 22 kW or even more. In Mode 4 the EV is charged via an EV-charger in which direct current, DC, is used for charging the EV. Grid power is passed through an AC/DC inverter before being passed directly to the EV battery.

With an increasing number of EVs and charging equipment relating thereto, in particular Mode 3 chargers, a demand for both optimal use of available electrical power and enhanced safety is increased.

EP3184352A1 shows a system for use of available electrical power based on dynamic phase load distribution when charging batteries for electric vehicles. The document reveals an electrical circuit comprising at least one primary relay and at least one overcurrent protector connected between each phase conductors of a 3-phase network system and a 1- or 3-phase power outlet. A conductor with at least one relay is connected between the neutral input conductor and the neutral outlet of the standard electrical line. In another embodiment a circuit configuration enabling both 3-phase disconnection, provided by power relays on each phase conductor, and one-phase disconnection of loads from the mains supply is shown. This configuration ensures that all types of charger system may be connected to the 3-phase system.

While EP3184352A1 aims to optimize dynamic phase load distribution, there remains a need for improved safety related to EVSE and charging of EVs.

### SUMMARY OF THE DISCLOSURE

Embodiments herein aim to provide an electric vehicle supply equipment for charging of electrical vehicles, eliminating or at least reducing the problems and/or drawbacks associated with prior art solutions.

According to an embodiment, this is provided by an electric vehicle supply equipment, EVSE, for charging of electrical vehicles, the electrical vehicle supply equipment comprising internal circuitry with
an input of isolated conductors, the conductors being arranged to be connected to phases of a main distribution cable isolated conductors,
an output of isolated conductors being arranged to be connected to the conductors, the conductors being connectable to an electric vehicle for providing power for charging of at least one battery associated with the electric vehicle,
a primary set of relays, each relay within the set of relays being configured to selectively connect or disconnect electrical power provided from the main distribution cable via the input conductors to the output of isolated conductors,
   characterized in that the primary set of relays consists/comprises of seven relays, configured to selectively connect or disconnect electrical power provided from the main distribution cable via the input conductors in response to a second input signal and that the internal circuitry further comprises a safety relay, configured to connect or disconnect electrical power provided from the main distribution cable via the input conductors in response to a first input signal.

According to some embodiments, the input of isolated conductors further the electric comprises a neutral conductor being arranged to be connected to a neutral conductor of the main distribution cable isolated conductors, and the output of isolated conductors further comprising a neutral conductor, being arranged to be connected to the neutral conductor, and the primary set of relays and the safety relay, is configured to connect or disconnect electrical power provided from the main distribution cable via the input conductors in response to the input signals.

Since the internal circuitry comprises a safety relay arrangement which is configured to connect or disconnect electrical power provided from the main distribution cable via the input conductors in response to the first input signal, the safety relay arrangement may be used to cut the power in a reliable and efficient manner when needed. The input signals may be provided from any kind of internal or external control unit, and may e.g. be in the form of a Pulse Width Modulation (PWM)-signal or Pulse Duration Modulation (PDM)-signal.

The combination of the safety relay arrangement for power cut-off with the primary set of relays for optimized charging independently on whether the charging is realized via one phase or three phases provides for a both safer EVSE and more efficient charging than possible in prior-art solutions. The safety relay arrangement may for example be an all-pole relay.

Thus, hereby is provided an EVSE which enable a much higher level of safety, and which is eliminating or at least reducing the problems and/or drawbacks associated with prior art solutions. In addition, the EVSE according to embodiments herein provides for a less complex EVSE and internal circuit than known from the prior art. Also this provides for a safer and more robust solution with less risk for faults.

One objective with the EVSE according to embodiments described herein is compliance with IEC 62955, and/or IEC 62955:2018. The standard applies to residual direct current detecting devices (RDC-DD) for permanently connected AC electric vehicle charging stations such as mode 3 charging of electric vehicles, according to IEC 61851-1 and IEC 60364-7-722. They may be referred to as RDC-MD (residual direct current monitoring device) or RDC-PD (residual direct current protective device), for rated voltages not exceeding 440 V AC with rated frequencies of 50 Hz, 60 Hz or 50/60 Hz and rated currents not exceeding 125 A.

According to some embodiments the safety relay arrangement is configured to simultaneously disconnect all electrical power from the main distribution cable via the input conductors in response to the first input signal. Since the safety relay arrangement is configured to simultaneously disconnect all electrical power from the main distribution cable via the input conductors in response to the input signal, it forms an “internal” safety switch, which renders external safety arrangements, with dedicated mounting, skins etc. unnecessary,

According to some embodiments the safety relay arrangement is arranged to receive the first input signal in form of a PWM-pulse. This is an efficient and reliable manner to provide an input signal to the safety relay arrangement.

According to some embodiments, the safety relay is arranged to be a single component, and the first input signal has two states indicating all relays in the safety relay to be one of OPEN or CLOSED.

According to a further embodiments the safety relay arrangement comprises four individual relays, each individual relay may be configured to selectively connect or disconnect electrical power to a respective one of four isolated conductors in response to an alternative first input signal to the respective individual relay.

According to some embodiments the safety relay arrangement is arranged between the input of isolated conductors and the primary set of relays.

According to some embodiments the primary set of relays comprises seven individual relays.

According to some embodiments, one or both of the safety relay and the primary set of relays is composed of Solid State Relays, SSR.

According to some embodiments the EVSE comprises a weld test arrangement which is connected to the safety relay arrangement. The weld test, or weld check, arrangement can be mechanically coupled to the safety relay arrangement. Hereby weld test of the primary set of relays may be performed by voltage measurement, and due to this it is possible to use less expensive relays in the primary set of relays.

According to some embodiments, the weld test arrangement comprises one or more of:
a meter arranged to measure and validate activity through the safety relay towards a predefined measurement values, and
a voltage meter arranged to measure voltage on output conductors when safety relay is in a CLOSED state, and the primary set of relays are all in an OPEN state.

Thus, hereby is provided an EVSE eliminating or at least reducing the problems and/or drawbacks described above.

Embodiments herein also aim to provide an electric vehicle charger without the problems or drawbacks described above.

According to some embodiments, this is provided by an electric vehicle charger wherein it comprises a housing and at least one electric vehicle supply equipment according to embodiments described herein.

Embodiments herein also aim to provide a charging system for electric vehicles without the problems or drawbacks described above. According to some embodiments, this is provided by a charging system for electric vehicles, wherein it comprises a plurality of electric vehicle chargers according to embodiments described herein. Hereby an entire fleet or group of chargers comprises safety relays on each individual charger.

Embodiments herein also aim to provide a method for controlling an electric vehicle supply equipment without the problems or drawbacks described above.

According to some embodiments, this is provided by a method for controlling an electric vehicle supply equipment for charging of electrical vehicles, the electrical vehicle supply equipment comprising internal circuitry with
an input of isolated conductors arranged to be connected to phases and a neutral conductor of a main distribution cable isolated conductors,
an output of isolated conductors which are connectable to an electric vehicle for providing power for charging of at least one battery associated with the electric vehicle,
a primary set of relays, each relay within the set of relays being configured to selectively connect or disconnect electrical power provided from the main distribution cable via the input conductors to the output of isolated conductors,
   wherein the method comprises the steps;
providing a first input signal to a safety relay arrangement of the internal circuitry,
selectively connect or disconnect electrical power provided from the main distribution cable via the input conductors in response to the input signal.

Since the method comprises the steps of providing a first input signal to a safety relay arrangement of the internal circuitry and selectively connect or disconnect electrical power provided from the main distribution cable via the input conductors in response to the input signal, the method can be used to quickly cut the power when needed.

Further features of, and advantages with, the embodiments herein will become apparent when studying the appended claims and the following detailed description. Those skilled in the art will realize that different features of the embodiments herein may be combined to create embodiments other than those described in the following, without departing from the scope of the appended claims.

### BRIEF DESCRIPTION OF THE FIGURES

The various aspects of embodiments herein, including its particular features and advantages, will be readily understood from the following detailed description and the accompanying drawings, in which:

FIG. 1 illustrates an electric vehicle supply equipment according to some embodiments.

FIG. 2 illustrates EV chargers and a charging system for electric vehicles according to some alternative embodiments.

FIG. 3 illustrates a method for controlling an electric vehicle supply equipment.

FIG. 4 is a design layout diagram of an example embodiment of the EVSE according to present disclosure

FIG. 5A shows the relay configuration for an IT (Insulated Terra) system

FIG. 5B shows the relay configuration for an TN (Terra Neutral) system

FIG. 6 is a flow diagram for the weld check process

FIG. 7 shows one embodiment of an exploded view of components of a wall mounted of EVSE according to present disclosure

### DETAILED DESCRIPTION OF THE DISCLOSURE

Embodiments herein will now be described more fully with reference to the accompanying drawings, in which example embodiments are shown. However, this application should not be construed as limited to the embodiments set forth herein. Disclosed features of example embodiments may be combined as readily understood by one of ordinary skill in the art to which this application belongs. Like numbers refer to like elements throughout.

Well-known functions or constructions will not necessarily be described in detail for brevity and/or clarity.

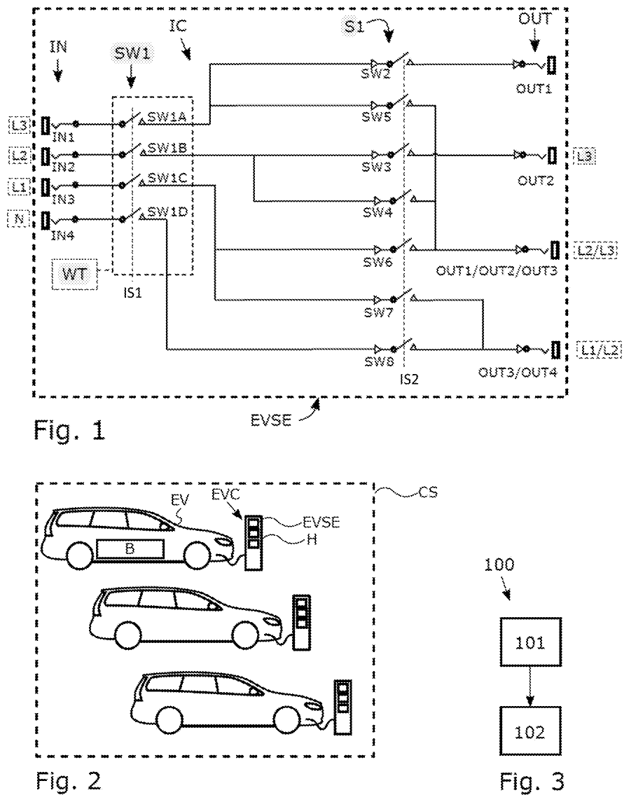

FIG. 1 illustrates an electric vehicle supply equipment, EVSE, for charging of electrical vehicles EV. In a mounted position, the EVSE and IC may constitute parts of an EV-charger EVC, schematically illustrated in FIG. 2. The EV may be a chargeable vehicle in form of a car, fully electric or a plug-in-hybrid. Alternatively it may be any other kind of electric vehicle, such as a motorcycle, bicycle, scooter, skateboard, railcar, watercraft, forklift, bus or truck.

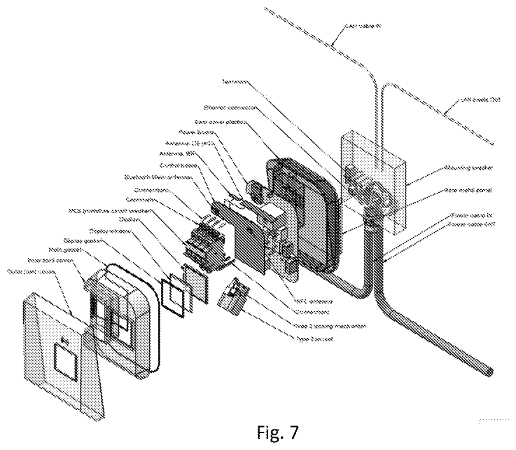

The EVC, illustrated in one of possible embodiment examples in FIG. 7, according to embodiments described herein may have inlet- and outlet ports for electrical power cables, and inlet- and outlets for connection to a LAN-network. The power cables may connect to terminals of the EV-charger. It may comprise a housing H with a rear cover and a front cover for housing of all necessary components there between. The EVC may comprise a power board, antennas e.g. for 4G, 5G, WIFI, NFC and Bluetooth for communication in a known manner. Thus, the EVC may communicate with other EVCs in a predefined system of EVCs, and also with the cloud/external servers, various service providers and the like.

In a further embodiment of the EVC it comprises at least one control unit CU and at least one communication arrangement CA, arranged to selectively connect or disconnect each relay within the primary set of relays SW2, SW3, SW4, SW5, SW6, SW7, SW8 and to transmit and receive relay status to and from other electric vehicle supply equipments EVSE.

In an even further embodiment of the EVC, the EVC comprises at least one control unit CU and at least one communication arrangement CA and an electric vehicle supply equipments EVSE according to present disclosure.

It is further provided a charging system CS comprising a plurality of electric vehicle chargers EVC as described in present disclosure.

The EVC may comprise a control board, grammets and a circuit breaker such as a miniature circuit breaker MCB. It may also comprise a display for presentation of relevant charging information to a user of the EVC.

The EVC comprises an outlet to which a charging cable for EVs may connect. The outlet may be in form of a Type 2 socket or any other kind of suitable socket. The outlet may comprise a locking mechanism for locking the cable to the socket, and for hindrance of unauthorized use of the EVC.

The EVSE comprises internal circuitry IC. The IC may be arranged as a printed circuit board PCB. The PCB mechanically supports and electrically connects electrical or electronic components using conductive tracks, pads and other features etched from one or more sheet layers of copper laminated onto and/or between sheet layers of a non-conductive substrate. Components can be soldered onto the PCB to both electrically connect and mechanically fasten them to it.

The EVSE comprises an input IN of isolated conductors IN1, IN2, IN3, IN4. The input IN of isolated conductors IN1, IN2, IN3, IN4 is arranged to be connected to phases L1, L2, L3 and a neutral conductor N of a main distribution cable isolated conductors, as schematically shown in the left part of FIG. 1.

The EVSE comprises an output OUT of isolated conductors OUT1, OUT2, OUT3, OUT4 which are connectable to an electric vehicle EV for providing power for charging of at least one battery B associated with the electric vehicle EV. The output OUT of isolated conductors OUT1, OUT2, OUT3, OUT4 may be arranged in a plug or socket of the EVC, to which a complementary socket or plug of the EV may be connected in a known manner via a cable.

The EVSE comprises a primary set S1 of relays SW2, SW3, SW4, SW5, SW6, SW7, SW8. Each relay SW2, SW3, SW4, SW5, SW6, SW7, SW8 within the set S1 of relays is configured to selectively connect or disconnect electrical power provided from the main distribution cable via the input conductors IN1, IN2, IN3, IN4 to the output OUT of isolated conductors OUT1, OUT2, OUT3, OUT4. The EVSE with the primary set S1 of relays enable optimized charging through full dynamic load balancing.

In FIG. 1 it is also shown that the internal circuitry IC comprises a safety relay arrangement SW1. The safety relay arrangement SW1 is configured to selectively connect or disconnect electrical power provided from the main distribution cable via the input conductors IN1, IN2, IN3, IN4 in response to a first input signal IS. The safety relay arrangement SW1 can be configured to simultaneously disconnect all electrical power from the main distribution cable via the input conductors IN1, IN2, IN3, IN4 in response to the input signal IS. The safety relay arrangement SW1 may be referred to as a IEC 62955-compliant safety relay arrangement. The safety relay arrangement can suitably be used for the ordinary on/off-controlling of the voltage to the EVSE. It may thus be used for on/off during normal operation, and in addition for cutting the power if any faults are detected. With the EVSE according to embodiments described herein, “double-safety” is achieved, if the safety relay arrangement for some reason would fail, the primary set of relays can still be used for cutting the power. However, normally the primary set of relays are switched in a state without load. The input signals IS to the safety relay arrangement and the primary set of relays may be in any suitable format, e.g. in form of a PWM-pulse.

In some embodiments the safety relay arrangement SW1 comprises four individual relays SW1A, SW1B, SW1C, SW1D. In some other embodiments, not illustrated, the safety relay arrangement SW1 comprises a smaller number of individual relays, such as one, two or three individual relay(s). Alternatively, in a further embodiment, it comprises more than four relays. Each individual relay SW1A, SW1B, SW1C, SW1D may be configured to selectively connect or disconnect electrical power to a respective one of four isolated conductors (IN1, IN2, IN3, IN4) in response to an alternative first input signal to the respective individual relay SW1A, SW1B, SW1C, SW1D.

In a similar manner the relays SW2, SW3, SW4, SW5, SW6, SW7, SW8 of the primary set S1 of relays are controlled via a second input signals. The state of each relay may be set in accordance to the load, i.e. in dependence of whether one or three phases are available, the number of used EVCs within the same EVC-system and the like.

If the first input signal IS1 to the safety relay arrangement SW1 includes a “power-shut-off” signal, the relays will shut off the power. If the input signal IS1 to the safety relay arrangement SW1 includes an activation signal, the relay or relays within the safety relay arrangement SW1 will allow electric power to the primary set S1 of relays. The safety relay arrangement can be configured to disconnect electrical power solely to the primary set of relays. Thus, no other electrical equipment or electrical conductors are affected of the power cut-off by the safety relay arrangement.

Thus, the safety relay arrangement SW1 may be referred to as a dedicated safety relay arrangement SW1 with the sole purpose to cut off/turn on electricity, while the primary set of relays are made for distributing electricity in an optimized manner between the isolated output conductors.

The input signal IS1, IS2 may be provided from any kind of external control unit. In some embodiments, the EVC comprises a control unit and/or communication means. The first input signal IS1 may then be provided the safety relay arrangement from the control unit. The input signal may e.g. be initiated or provided in at least one of the following scenarios;
a current above a predetermined value is detected or communicated to the EVSE,
a fault in the EVSE is detected,
a fault in a cable, battery or other external equipment connected to the EVSE is detected or communicated to the EVSE,
a detected reverse DC current,
the EVSE is used in an unauthorized manner, or by an unauthorized person.

Thus, the safety relay SW1 may be connected to a communication arrangement CA, enabling the safety relay SW1 to be remotely controlled (not shown),

FIG. 3 illustrates a method 100 for controlling an electric vehicle supply equipment EVSE for charging of electrical vehicles EV, the electrical vehicle supply equipment EVSE comprising internal circuitry IC with
an input IN of isolated conductors L1in,L2 in,L3 in, the conductors L1in ,L2 in,L3in being arranged to be connected to phases L1,L2,L3 of a main distribution cable isolated conductors, an output OUT of isolated conductors L1out,L2out,L3out being arranged to be connected to the conductors L1in , L2 in,L3 in, the conductors L1out, L2out, L3out being connectable to an electric vehicle EV for providing power for charging of at least one battery B associated with the electric vehicle EV,a primary set S1 of relays, each relay within the set S1 of relays being configured to selectively connect or disconnect electrical power provided from the main distribution cable via the input conductors L1in ,L2 in,L3in to the output OUT of isolated conductors L1out, L2out, L3out, characterized in that the primary set S1 of relays consists/comprises for example seven relays SW2,SW3,SW4,SW5,SW6,SW7,SW8, configured to selectively connect or disconnect electrical power provided from the main distribution cable via the input conductors L1in ,L2 in,L3in in response to a second input signal IS2,
   the internal circuitry IC further comprises a safety relay SW1, configured to connect or disconnect electrical power provided from the main distribution cable via the input conductors L1in ,L2 in,L3in in response to a first input signal IS1.

In a further embodiment of internal circuitry IC comprised in the electrical vehicle supply equipment EVSE:
the input IN of isolated conductors further comprises a neutral conductor Nin being arranged to be connected to a neutral conductor N of the main distribution cable isolated conductors, and the output OUT of isolated conductors further comprising a neutral conductor Nout, being arranged to be connected to the neutral conductor Nin, and the primary set S1 of relays SW2,SW3,SW4,SW5,SW6,SW7,SW8 and the safety relay SW1, is configured to connect or disconnect electrical power provided from the main distribution cable via the input conductors Nin,L1in ,L2 in,L3in in response to an input signals IS2,IS1.

The primary set S1 of relays maybe configured to comprise more or less relays in order to accommodate or custom fit to other routing configurations of the conductors N, L1, L2, L3 between input IN and output OUT.

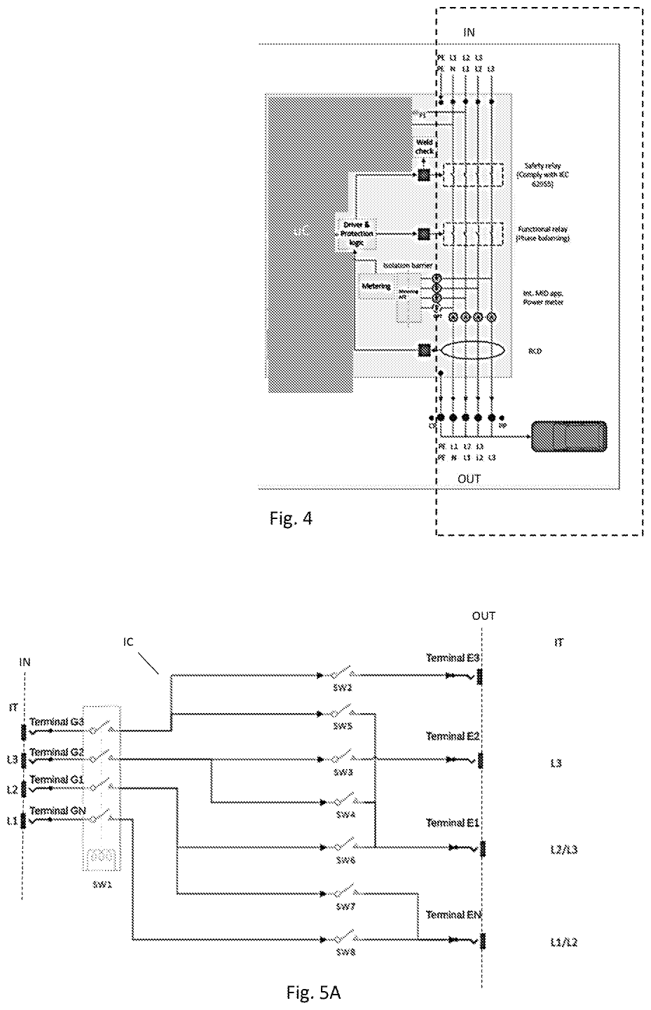

Now a further embodiment of the electric vehicle supply equipment, EVSE, is discussed as described by FIGS. 4-9.

FIG. 4 illustrates a layout diagram of one embodiment of the EVSE according to present disclosure. The layout is not limiting for the present invention, but is to be read as an optional design that may provide features and functionality of one or more, but not limited to, the features listed below:

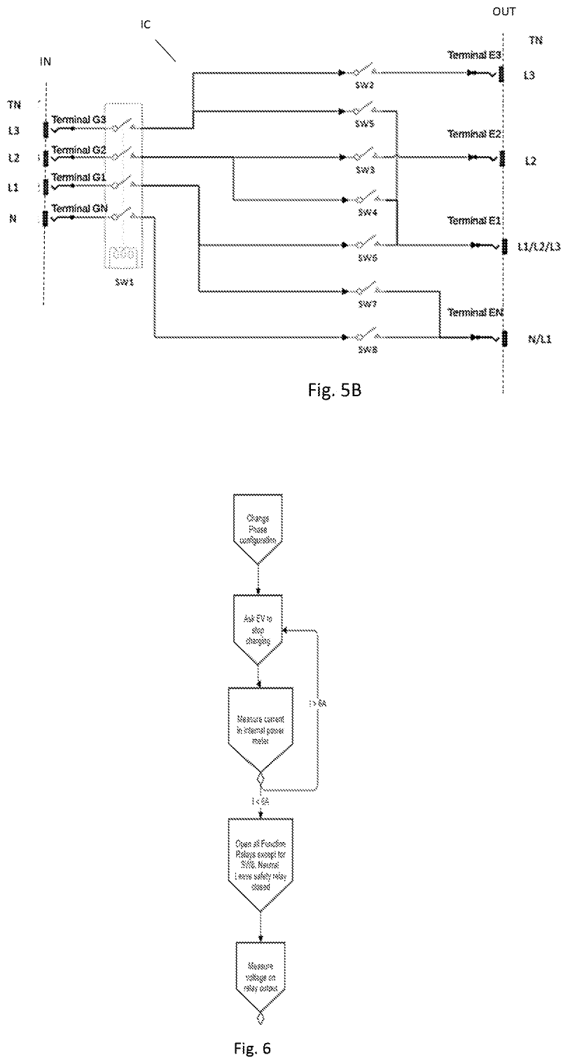

In FIGS. 5A and 5B it is shown how the relay configuration for an IT (Isolated Terra) and TN (Terra Neutral) system respectively may be facilitated using present relay setup.

The unique security relay is implemented as a single component device that on certain predefined conditions will switch off all relays connected to the power grid phases GN, G1, G2, G3 equivalent to when configured for use in an IT system: L1, L2 and L3, and when configured for a TN system: N, L1, L2, L3. In this embodiment the first input signal IS1 has two states indicating all relays in the safety relay SW1 to be one of OPEN or CLOSED.

The IT system utilizes only the Terminal GN, Terminal G1 and Terminal G2 conductors for corresponding L1, L2, and L3.

The TN system utilizes the Terminal GN, Terminal G1, Terminal G2 and Terminal G3 conductors for corresponding N, L1, L2, and L3.

The TN system is specifically unique in that The Terminal EN is controlled by 2 relays only.

In a further embodiment of the EVSE of present disclosure one or both of the safety relay SW1 and the primary set S1 of relays is composed of Solid State Relays, SSR.

The figures enables various charging configurations available for an IT system, revealing that by altering the functional relay comprising the 7 individual relays SW2-SW8, it is possible to configure 4 different configurations according to the table 1 below.

Further configurations available for an TN system is shown, revealing that by altering the functional relay comprising the 7 individual relays SW2-SW8, it is possible to configure 7 different active configurations, and 2 non-conducting configurations according to the table 1 below.

Additionally both systems, IT and TN, may offer the all functional relays in an open state, wherein no charging is performed/available.

It is therefore provided, according to present disclosure, a system that may support 12 or more different power supply configurations by controlling the conductor routing over the 4 conductors by 7 relays only.

TABLE 1
Available configurations (0 denotes functional
relay OPEN, 1 denotes functional relay CLOSED)

| System | SW2 | SW3 | SW4 | SW5 | SW6 | SW7 | SW8 | GN | G1 | G2 | G3 | Type |
|---|---|---|---|---|---|---|---|---|---|---|---|---|
| IT | 0 | 0 | 0 | 0 | 1 | 0 | 1 | EN | E1 | X | X | IT1P1 |
| IT | 0 | 0 | 1 | 0 | 0 | 1 | 0 | X | EN | E1 | X | IT1P2 |
| IT | 0 | 0 | 1 | 0 | 0 | 0 | 1 | EN | X | E1 | X | IT1P3 |
| IT | 0 | 1 | 0 | 0 | 1 | 0 | 1 | EN | E1 | E2 | X | IT3P1 |
| IT | 0 | 0 | 0 | 0 | 0 | 0 | 0 | X | X | X | X | ITX |
| TN | 1 | 1 | 0 | 0 | 1 | 0 | 1 | EN | E1 | E2 | E3 | TN3P1 |
| TN | 0 | 1 | 0 | 0 | 1 | 0 | 1 | EN | E1 | E2 | X | TN2P1 |
| TN | 0 | 1 | 0 | 1 | 0 | 0 | 1 | EN | X | E2 | E1 | TN2P2 |
| TN | 1 | 0 | 0 | 0 | 1 | 0 | 1 | EN | E1 | X | E3 | TN2P3 |
| TN | 0 | 0 | 0 | 0 | 1 | 0 | 1 | EN | E1 | X | X | TN1P1 |
| TN | 0 | 0 | 1 | 0 | 0 | 0 | 1 | EN | X | E1 | X | TN1P2 |
| TN | 0 | 0 | 0 | 1 | 0 | 0 | 1 | EN | X | X | E1 | TN1P3 |
| TN | 0 | 0 | 0 | 0 | 0 | 0 | 0 | X | X | X | X | TNX |

As illustrated in FIG. 4 the weld check is outlined as a feature implemented in various manners, and a first weld check is performed on the safety relay by measuring activity when vehicle is connected. Security relay is initially open, and when car is connected these are closed. Measurement may then reveal faults by comparing against predefined measurement values. Any deviations from a valid measurement will raise a fault condition resulting in a common breaking of the safety relay for all conductors.

The weld check may further comprise a different measurement method for discovering faults in the functional relays, wherein each individual relay is measured before connection of the EV, where there should be 0 voltage difference over the relay since all the conductors should in this case before any configuration is chosen be an open circuit. This process is exemplified in FIG. 6, wherein upon the action of changing a phase configuration, the EV is instructed to stop charging, and the internal meter performs a safety check that none of the conductors are active. If active above a present value then mitigating efforts will be provided to prevent further operation.

Safety relay should be closed when the measurement is performed on the functional relay. By measure the voltage on the output, and detecting other value than 0 will indicate a faulty non-open functional relay. Security measures should in this case be taken not to use the faulty conductor.

A further advantageous feature of present device according to the present disclosure is that all conductors may comprise DC current meters to discover any back currents from the battery of the EV due to any faults in the distribution path between the electrical grid and the EV. If this monitoring detects any back current flows this will immediately break all conductors in the security relay.

When considering the TN configurations there is a further advantageous aspect in that only 2 relays are involved in exploitation of the N phase conductor, Safety relay GN and SW8.

The Driver and Protection Logic comprising the weld check features, also comprise a real time monitoring/reading of any individual relay status. Thus it is possible to detect any stuck or malfunctioning relay that is not operating as intended for any of the configurations discussed above.

The surveillance metering of the current and voltage may be performed on each individual conductor between the functional relay and the out ports as indicated in FIG. 4.

Any faults detected may either activate the safety shut off of all relays in the safety relay, or any and/or all if the conductors may be shut off in the functional relay.

The functional relay may be controlled to provide phase balancing.

A second aspect of this disclosure provides a method a method 100 for controlling an electric vehicle supply equipment EVSE as described in present disclosure the method comprises the steps;
providing (101) a first input signal IS1 to a safety relay arrangement SW1 of the internal circuitry IC of the EVSE,
connect or disconnect (102) electrical power provided from the main distribution cable via the input conductors (IN1, IN2, IN3, IN4) in response to the input signals (IS1, IS2).

A third aspect of this disclosure shows an electric vehicle charger VC wherein it comprises a housing H, at least one control unit CU and at least one communication arrangement CA and an electric vehicle supply equipment EVSE according to the present disclosure.

The fourth aspect of this disclosure shows a charging system CS for electric vehicles EV, wherein it comprises a plurality of electric vehicle chargers VC according to the present disclosure.

Although the aspects has been described with reference to example embodiments, many different alterations, modifications and the like will become apparent for those skilled in the art. Therefore, it is to be understood that the foregoing is illustrative of various example embodiments and the scope of the appended claims is not to be limited to the specific embodiments disclosed and that modifications to the disclosed embodiments, combinations of features of disclosed embodiments as well as other embodiments are intended to be included within the scope of the appended claims.

As used herein, the term “comprising” or “comprises” is open-ended, and includes one or more stated features, elements, steps, components or functions but does not preclude the presence or addition of one or more other features, elements, steps, components, functions or groups thereof.

1. An electric vehicle supply equipment for charging of electrical vehicles, the electrical vehicle supply equipment comprising internal circuitry with
an input of isolated conductors, the conductors being arranged to be connected to phases of a main distribution cable isolated conductors,
an output of isolated conductors being arranged to be connected to the input isolated conductors, the output isolated conductors being connectable to an electric vehicle for providing power for charging of at least one battery associated with the electric vehicle,
a primary set of relays, each relay within the primary set of relays being configured to selectively connect or disconnect electrical power provided from the main distribution cable via the input isolated conductors to the output of isolated conductors,
characterized in that the primary set of relays consists/comprises of seven relays, configured to selectively connect or disconnect electrical power provided from the main distribution cable via the input isolated conductors in response to a second input signal
and that the internal circuitry further comprises a safety relay, configured to connect or disconnect electrical power provided from the main distribution cable via the input isolated conductors in response to a first input signal.

2. The electric vehicle supply equipment of claim 1, wherein
the input of isolated conductors further comprising a neutral in conductor being arranged to be connected to a neutral conductor of the main distribution cable isolated conductors, and
the output of isolated conductors further comprising a neutral out conductor, being arranged to be connected to the neutral in conductor, and
the primary set of relays and the safety relay, is configured to connect or disconnect electrical power provided from the main distribution cable via the input isolated conductors in response to the input signals.

3. The electric vehicle supply equipment of claim 1, wherein the safety relay is arranged between the input of isolated conductors and the primary set of relays.

4. The electric vehicle supply equipment of claim 1, wherein the internal circuitry comprises at least one control unit which is arranged to control the safety relay to disconnect all electrical power to the primary set of relays from the input isolated conductors in response to the first input signal indicative of at least one of the following parameters;
a current is above a predetermined threshold value,
a reverse DC current.

5. The electric vehicle supply equipment of claim 1, wherein the safety relay is arranged to be a single component, and the first input signal has two states indicating all relays in the safety relay to be one of OPEN or CLOSED.

6. The electric vehicle supply equipment of claim 1, wherein one or both of the safety relay and the primary set of relays is composed of Solid State Relays, SSR.

7. The electric vehicle supply equipment of claim 1, wherein the safety relay is connected to a communication arrangement, enabling the safety relay to be remotely controlled.

8. The electric vehicle supply equipment of claim 1, wherein the safety relay comprises at least one mechanical switch.

9. The electric vehicle supply equipment of claim 1, further comprising a weld test arrangement comprising one or more of:
a meter arranged to measure and validate activity through the safety relay towards a predefined measurement values, and
a voltage meter arranged to measure voltage on output conductors when safety relay is in a CLOSED state, and the primary set of relays are all in an OPEN state.

10. The electric vehicle supply equipment of claim 1, wherein the function of the safety relay is to connect or disconnect electrical power, and the function of the primary set of relays is to distribute the electrical power in a predetermined manner between the isolated conductors.

11. The electric vehicle supply equipment of claim 1, wherein the primary set of relays is controlled to distribute the electrical power in a optimized manner between the isolated conductors independently of whether the electrical power is provided from the main distribution cable via one phase or three phases.

12. The electric vehicle supply equipment of claim 1, further comprising wherein it comprises at least one control unit and at least one communication arrangement, to selectively connect or disconnect each relay within the primary set of relays and to transmit and receive relay status to and from other electric vehicle supply equipments.

13. An electric vehicle charger comprising a housing, at least one control unit and at least one communication arrangement and an electric vehicle supply equipment of claim 1.

14. A charging system for electric vehicles, comprising a plurality of electric vehicle chargers of claim 13.
